(19) United States
(12) Patent Application Publication
(10) Pub. No.: US 2009/0033202 A1
(43) Pub. Date: Feb. 5, 2009

(54) Image Display Device

(76) Inventor: Takaaki Ogasa, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/127,853

(22) Filed: May 28, 2008

(30) Foreign Application Priority Data
Jul. 31, 2007 (JP) 2007-199791

(51) Int. Cl. H01J 1/62

(52) U.S. Cl. 313/496

(57) ABSTRACT

An exhaust hole (10) formed in a cathode substrate (1) is surrounded by an exhaust substrate (6), an exhaust substrate frame (71), and a sealing material (32) so that an exhaust chamber is formed. An exhaust substrate exhaust hole (81) is formed in the exhaust substrate (6), and an exhaust tube (8) is connected to the exhaust substrate exhaust hole (81) to evacuate an interior of a display device. If an end part of the exhaust hole (10) has a sharp edge, sparking will start to occur at the edge. To address this problem, a chamfer (101) is formed on the exhaust hole (10). Similarly, chamfers may be formed on the exhaust substrate exhaust hole (81) and a high-voltage introduction button hole (82). Forming such chamfers can prevent sparking originating from the edges of the exhaust hole (10) and the like formed in the cathode substrate (1) and the like.

### CROSS-REFERENCE TO RELATED APPLICATION

The present application claims priority from Japanese application JP2007-199791 filed on Jul. 31, 2007, the content of which is hereby incorporated by reference into this application.

### BACKGROUND OF THE INVENTION

1. Field of the Invention

The present invention relates to a flat-panel display device comprising electron sources disposed in a matrix on a rear substrate, phosphors disposed correspondingly on a front substrate, and an interior evacuated to a vacuum. The invention also relates to a technology for improving the withstand voltage characteristics and manufacturing yield of the display device.

2. Description of the Related Art

Color cathode-ray tubes have been widely used as a high-brightness, high-definition display device. However, the demand for flat-panel image display devices has been increasing due to considerations of, for example, a reduction in size and weight. Since liquid crystal display devices, plasma display devices, or other flat-panel display devices do not weigh much even when they have a large screen size of 30 inches or greater, the demand for such display devices has also increased in the field of televisions and other large-screen display devices.

On the other hand, field emission displays (hereinafter referred to as FED) are currently being developed. In an FED, electron sources are disposed on a cathode substrate in a matrix, phosphors are disposed on an anode substrate that faces the cathode substrate, and the space between the two glass substrates is evacuated. An FED is a display device in which electrons from the electron sources impinge on the phosphors, and light is emitted to form an image. An FED presents, for example, excellent brightness, contrast, moving-image characteristics, and other attributes that are comparable to those of a cathode-ray tube, and hence is a promising future TV display.

Since an FED is a display device in which electrons emitted from the electron sources impinge on the fluorescent surface and cause the phosphors to emit light, the inside of the display device should be evacuated. Specifically, the display device is manufactured by placing, for example, a glass frame at the peripheries of the cathode substrate on which the electron sources are formed and the anode substrate on which the fluorescent surface is formed so as to seal the two substrates. In general, the inside of the display device is evacuated by drilling a hole in the cathode substrate and connecting the hole to an exhaust tube. After the evacuation is completed, the exhaust tube is tipped off and sealed. Such an exhaust structure or sealing method is described, for example, in Japanese Laid-open Patent Application Nos. 2000-208051, 9-312131, 2003-068185, and 9-245649.

### SUMMARY OF THE INVENTION

To evacuate the inside of the display device, it is necessary to drill a hole for evacuation in a cathode substrate 1 or an anode substrate 2. In general, the hole is formed in the cathode substrate in consideration of the configuration of the display device. FIG. 24A is a schematic view of the cathode substrate 1 of an FED. In FIG. 24A, a large number of electron sources, scan lines, data signal lines, and other elements are formed in a display area 95 of the cathode substrate 1. An exhaust hole 10 is formed outside the display area 95. A getter hole 9 for a getter is formed at a position diagonally opposite the exhaust hole 10.

FIG. 24B shows a cross-sectional structure of the exhaust hole 10. The exhaust hole 10 is formed by using a glass grinding drill to drill a hole, and the end part S of the hole is a sharp edge. FIG. 24C is a plan view of the exhaust hole 10. A large number of tiny cracks 105 are generated around the exhaust hole 10 due to the drilling operation. In an FED, a high voltage ranging from 8 to 10 kV is applied between the cathode substrate 1 and the anode substrate 2. Therefore, when the cathode substrate has such a sharp edge, sparking occurs in this region, and hence the withstand voltage of the display device is lowered. The tiny cracks 105 in the end surface of the exhaust hole 10 worsen the problem of the lowered withstand voltage.

A large number of electron sources, scan lines, data signal lines, and other elements are formed on the cathode substrate 1. To form a large number of electron sources, scan lines, signal lines, and other elements on the cathode substrate 1, many photolithography processes involving a large number of steps are required. FIG. 25 shows an example of the photolithography process. As shown in FIG. 25, the photolithography process includes the steps of film formation, resist coating, exposure, development, etching, and resist removal. FIG. 26 shows a cross-sectional structure of the exhaust hole 10 and its neighboring area after a metal film MT is deposited and a patterning resist 250 is then coated in the process of forming the cathode substrate 1.

As shown in FIG. 26, the resist 250 formed around the exhaust hole 10 increases in thickness due to the surface tension as indicated by reference numeral 2501. FIG. 27 shows the resist 250 formed around the exhaust hole 10 and left even after the exposure and development. The resist 250 is developed after the exposure, but the portion where the resist 250 is thick will not be removed in the development step, as shown in FIG. 27. FIG. 28 shows the metal film MT left around the exhaust hole. Since the portion where the resist 250 is thick has not been removed, the metal film MT is disadvantageously left around the exhaust hole in the step of etching the metal film MT (FIG. 28). The presence of such a residual metal film, which is a conductor, around the exhaust hole 10 will further lower the withstand voltage of the display device.

While the above problems have been described with reference to the exhaust hole 10, the same holds for the getter hole 9. The same argument also applies to a case where a hole for introducing a high voltage is formed in the cathode substrate 1 and a case where other through-holes are formed in the cathode substrate 1. While the above problems have been described with reference to the cathode substrate 1, the same holds for a case where a hole is drilled in the anode substrate 2, because the formation of the anode substrate requires many photolithography processes involving a large number of steps to form red, green, and blue phosphors; a black matrix; and other elements.

The invention solves the problems described above primarily by using the following means.

(1) A display device comprising: a cathode substrate on which electron emitting sources are formed in a matrix; and an anode substrate that faces the cathode substrate, is impressed with an anode voltage, and has phosphors formed at positions that correspond to the electron emitting sources, the inside of the display device being maintained at a vacuum, wherein a through-hole is formed in the cathode substrate, and an end part of the through-hole facing the anode substrate is provided with a chamfer.

(2) The display device of (1), wherein the chamfer is a straight chamfer having a size of 0.05 mm or greater.

(3) The display device of (1), wherein the chamfer is a straight chamfer having a size of 0.5 mm or greater.

(4) The display device of (1), wherein the chamfer is a round chamfer having a radius of 0.05 mm or greater.

(5) The display device of (1), wherein the chamfer is a round chamfer having a radius of 0.5 mm or greater.

(6) The display device of (1), wherein the through-hole is an exhaust hole for evacuating the display device.

(7) The display device of (1), wherein both edges of the through-hole are provided with a chamfer.

(8) A display device comprising: a cathode substrate on which electron emitting sources are formed in a matrix; and an anode substrate that faces the cathode substrate, is impressed with an anode voltage, and has phosphors formed at positions that correspond to the electron emitting sources, the inside of the display device being maintained at a vacuum, wherein a through-hole is formed in the cathode substrate; a box-shaped portion is formed on a portion including the through-hole in a surface of the cathode substrate, the surface being opposite the anode substrate, the box-shaped portion being hermetically maintained at a vacuum; and an end part of the through-hole formed in the cathode substrate and facing the anode substrate is provided with a chamfer.

(9) The display device of (8), wherein an exhaust hole for evacuating the interior of the display device is formed in the box-shaped portion; and an end part of the exhaust hole is provided with chamfer.

(10) The display device of (8), wherein a high-voltage introduction terminal insert hole for supplying an anode voltage to the display device is formed in the box-shaped portion; and an end part of the high-voltage introduction terminal insert hole is provided with a chamfer.

(11) The display device of (8), wherein a contact spring for conducting electricity to the anode substrate is connected to a high-voltage introduction terminal; and the contact spring passes through the through-hole formed in the cathode substrate.

(12) The display device of (8), wherein a getter for maintaining the vacuum in the display device is disposed in the box-shaped portion.

According to the invention, since the end part of the through-hole formed in the cathode substrate is provided with a chamfer, it is possible to prevent an electric field from concentrating at the end part of the through-hole and hence prevent the edge from being a point where sparking starts. It is therefore possible to prevent the withstand voltage of the display device from decreasing. Forming the chamfer at the through-hole can also prevent tiny cracks from being generated at the end part of the through-hole. As a result, it is possible to prevent such tiny cracks from breaking away to form foreign matter in the display device and hence prevent the withstand voltage from decreasing.

The formation of the chamfer at the through-hole can also prevent a thick resist from being left at the end part of the through-hole when a film is formed on the cathode substrate in a photolithography process, and thereby prevents the resist from being left in a development step. It is therefore possible to address the problem of decreases in the withstand voltage due to a metal film or other residue left around the through-hole.

While the above advantages have been described with reference to a case where an edge of an exhaust hole or other through-hole in the cathode substrate is provided with a chamfer, it is also possible to prevent the withstand voltage from decreasing in a case where an exhaust substrate for evacuation purposes is attached to the cathode substrate and an exhaust hole is formed in the exhaust substrate, or a case where a hole for a high-voltage introduction terminal is formed in the exhaust substrate, by providing a chamfer to the holes in each case. It is also possible to prevent the withstand voltage from decreasing in a case where a getter hole is formed in the exhaust substrate by chamfering an edge of the getter hole.

### BRIEF DESCRIPTION OF THE DRAWINGS

FIG. 1 is a plan view showing a first embodiment of the invention;

FIG. 2 is a side view of FIG. 1;

FIG. 3 is a cross-sectional view taken along the line A-A in FIG. 1;

FIG. 4 is a cross-sectional view taken along the line B-B in FIG. 1;

FIG. 5 is a cross-sectional view taken along the line C-C in FIG. 1;

FIG. 6 is a cross-sectional view showing the shape of a chamfer at an exhaust hole;

FIG. 7 is a schematic cross-sectional view showing the exhaust hole and its neighboring area in a photolithography process;

FIG. 8 is a schematic view showing how to form a straight chamfer at an exhaust hole;

FIG. 9A is a plan view showing a lower electrode deposited on a cathode substrate;

FIG. 9B is a cross-sectional view taken along the line A-A′ in FIG. 9A;

FIG. 9C is a cross-sectional view taken along the line B-B′ in FIG. 9A;

FIG. 10A is a plan view showing the lower electrode after being patterned;

FIG. 10B is a cross-sectional view taken along the line A-A′ in FIG. 10A;

FIG. 10C is a cross-sectional view taken along the line B-B′ in FIG. 10A;

FIG. 11A is a plan view showing the lower electrode after being anodized;

FIG. 11B is a cross-sectional view taken along the line A-A′ in FIG. 11A;

FIG. 11C is a cross-sectional view taken along the line B-B′ in FIG. 11A;

FIG. 12A is a plan view showing a tunnel insulating film formed on the lower electrode;

FIG. 12B is a cross-sectional view taken along the line A-A′ in FIG. 12A;

FIG. 12C is a cross-sectional view taken along the line B-B′ in FIG. 12A;

FIG. 13A is a plan view showing a two-layer insulating film and an upper bus electrode deposited on the lower electrode;

FIG. 13B is a cross-sectional view taken along the line A-A′ in FIG. 13A;

FIG. 13C is a cross-sectional view taken along the line B-B′ in FIG. 13A;

FIG. 14A is a plan view showing the upper bus electrode after being patterned;

FIG. 14B is a cross-sectional view taken along the line A-A′ in FIG. 14A;

FIG. 14C is a cross-sectional view taken along the line B-B′ in FIG. 14A;

FIG. 15A is a plan view showing the formation of a contact hole;

FIG. 15B is a cross-sectional view taken along the line A-A′ in FIG. 15A;

FIG. 15C is a cross-sectional view taken along the line B-B′ in FIG. 15A;

FIG. 16A is a plan view showing a deposited contact electrode;

FIG. 16B is a cross-sectional view taken along the line A-A′ in FIG. 16A;

FIG. 16C is a cross-sectional view taken along the line B-B′ in FIG. 16A;

FIG. 17A is a plan view showing the patterned contact electrode;

FIG. 17B is a cross-sectional view taken along the line A-A′ in FIG. 17A;

FIG. 17C is a cross-sectional view taken along the line B-B′ in FIG. 17A;

FIG. 18A is a plan view showing an etched silicon film;

FIG. 18B is a cross-sectional view taken along the line A-A′ in FIG. 18A;

FIG. 18C is a cross-sectional view taken along the line B-B′ in FIG. 18A;

FIG. 19A is a plan view showing a patterned silicon nitride film;

FIG. 19B is a cross-sectional view taken along the line A-A′ in FIG. 19A;

FIG. 19C is a cross-sectional view taken along the line B-B′ in FIG. 19A;

FIG. 20A is a plan view showing an upper electrode formed on an electron source;

FIG. 20B is a cross-sectional view taken along the line A-A′ in FIG. 20A;

FIG. 20C is a cross-sectional view taken along the line B-B′ in FIG. 20A;

FIG. 21 is a cross-sectional view showing a round chamfer formed at an exhaust hole;

FIG. 22 is a cross-sectional view showing the exhaust hole and its neighboring area in a photolithography process;

FIG. 23 is a schematic view showing how to form a round chamfer;

FIG. 24A is a perspective view of a cathode substrate 1;

FIG. 24B is a cross-sectional view of an exhaust hole 10;

FIG. 24C is a plan view of the exhaust hole 10;

FIG. 25 is a flowchart showing a photolithography process;

FIG. 26 shows the state of a resist in the photolithography process in an example of related art;

FIG. 27 shows a residual resist around an exhaust hole in the example of related art;

FIG. 28 shows a residual metal film in the example of related art.

### DETAILED DESCRIPTION OF THE INVENTION

The best mode for carrying out the invention will be described below in detail with reference to the drawings of embodiments.

### First Embodiment

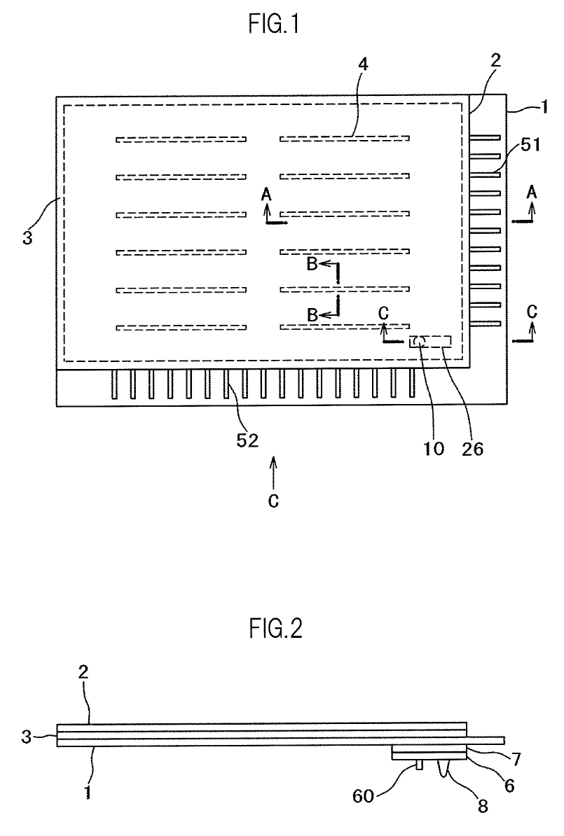

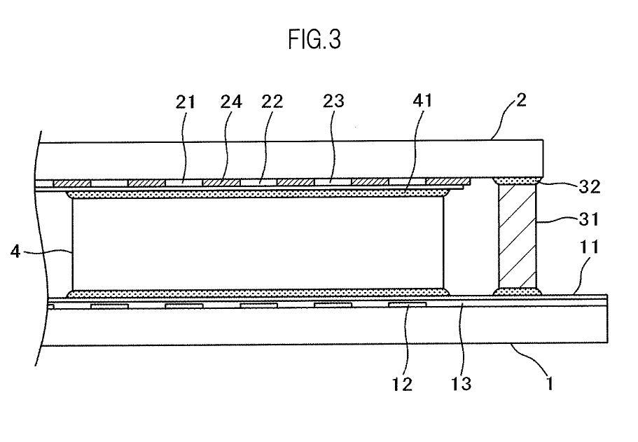

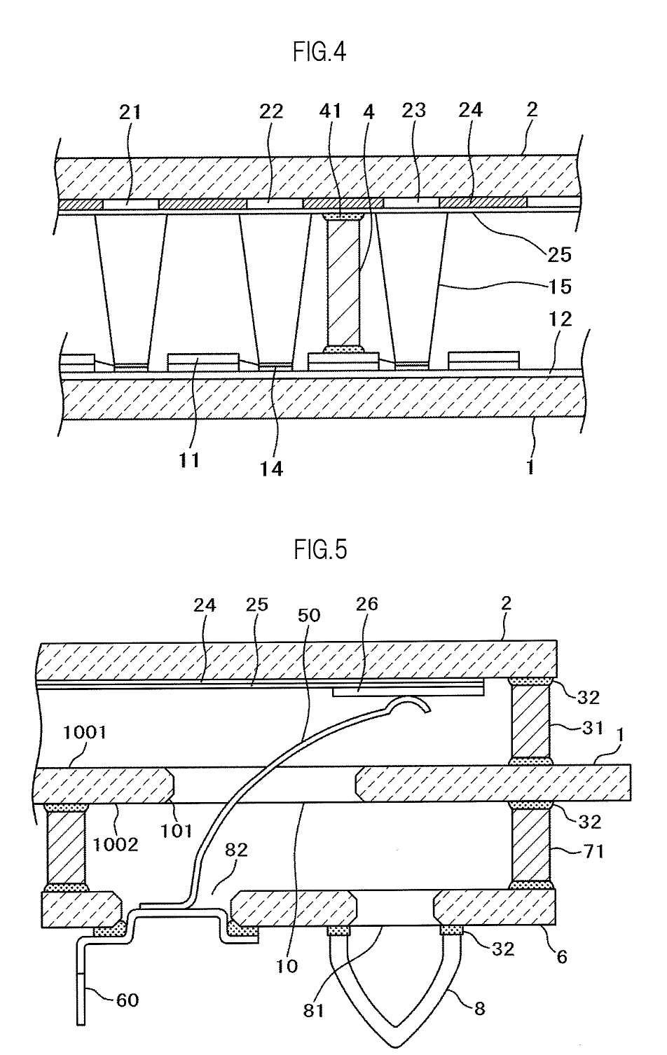

FIG. 1 is a plan view showing the structure of an FED according to a first embodiment of the invention. FIG. 2 is a side view of FIG. 1. FIG. 3 is a cross-sectional view taken along the line A-A in FIG. 1. FIG. 4 is a cross-sectional view taken along the line B-B in FIG. 1. The structure of the FED according to the embodiment will be described with reference to FIGS. 1 to 4. In FIG. 1, an anode substrate 2 is placed above a cathode substrate 1 with a sealing portion 3 therebetween. Scan lines 11 extend in the horizontal direction and data signal lines 12 extend in the vertical direction on the cathode substrate 1. Signals are externally supplied to the scan lines 11 via scan line terminals 51 and the data signal lines via data signal line terminals 52. Electron sources 14 are disposed in regions close to the intersections of the scan lines 11 and the data signal lines 12. Therefore, a large number of electron sources 14 are arranged in a matrix. A variety of electron sources have been developed, such as MIM, SED, and Spindt electron sources, and any of the electron sources can be applied to the invention. In the embodiment, MIM electron sources are used by way of example of the electron sources.

The space enclosed by the cathode substrate 1, the anode substrate 2, and the sealing portion 3 that surrounds their peripheries is maintained at a vacuum. Therefore, the atmospheric pressure bends the anode substrate 2 and the cathode substrate 1, so that the distance between the cathode substrate 1 and the anode substrate 2 cannot be kept uniform. In a worse case, the cathode substrate 1 and the anode substrate 2 are broken. To avoid such a situation, spacers 4 are provided between the cathode substrate 1 and the anode substrate 2. The spacer 4 is made of a ceramic or glass material and typically disposed on a scan line so as not to interfere with image formation.

Red, green, and blue phosphors, each of which emits light when an electron beam impinges thereon, are formed on the anode substrate 2 in correspondence with the electron sources. A black matrix (BM) is formed to surround the phosphors and improve image contrast. An aluminum metal back is formed so as to cover the black matrix. A high voltage is applied to the metal back 25. The high voltage accelerates electron beams 15 emitted from the cathode; and the electron beams 15 impinge on the red, green, and blue phosphors 21, 22, 23.

To use the electron beam 15 to produce light from each of the phosphors, the electron beam 15 needs to have a certain amount of energy. A high voltage ranging from 8 to 10 kV is therefore applied to the metal back 25 on the anode substrate 2. In the embodiment, a high-voltage introduction terminal is provided on the cathode substrate 1 side, and the high voltage is supplied through a contact spring to the anode substrate 2. In FIG. 1, an anode terminal 26 where the contact spring comes into contact with the anode substrate 2 is formed at a corner of the display device. Since the inside of the display device should be maintained at a vacuum, an exhaust hole 10 for evacuation purposes is formed at the corner of the display device in FIG. 1.

FIG. 2 is the side view of FIG. 1 when viewed in the direction C. In FIG. 2, the cathode substrate 1 faces the anode substrate 2 across a predetermined distance with the sealing portion 3 therebetween. The cathode substrate 1 is larger than the anode substrate 2 by an area on which the terminals 51, 52 and other elements are disposed. An exhaust substrate 6 to which an exhaust tube 8 and a high-voltage introduction button 60 are attached is attached to the bottom of the cathode substrate 1. The exhaust substrate 6 is attached to the cathode substrate 1 via an exhaust substrate sealing portion 7. FIG. 2 shows the tipped-off exhaust tube 8, which is connected to the exhaust substrate 6 and used to evacuate the interior of the display device. The high-voltage introduction button 60 is disposed in a vicinity of the exhaust tube 8.

FIG. 3 is a cross-sectional view taken along the line A-A in FIG. 1. In FIG. 3, the data signal lines 12 extend in the direction perpendicular to the plane of view. In the embodiment, the electron sources 14 are formed on the data signal lines 12. The scan lines 11 are formed via an insulating film 13 in the direction perpendicular to the data signal lines 12. In FIG. 3, the scan lines 11 extend to the area outside the sealing portion 3. The spacers 4, which keep the distance between the cathode substrate 1 and the anode substrate 2 uniform, are disposed on scan lines 11. The spacers 4 are bonded to scan lines on the cathode substrate 1 and to the metal back 25 on the anode substrate 2 using a bonding material 41. Each of the spacers 4 has a conductivity of approximately 10⁸ to 10⁹Ω, and conducting a small amount of current between the cathode and the anode prevents the spacer 4 from being charged.

The red, green, and blue phosphors 21, 22, 23 are disposed at locations on the anode substrate 2 that correspond to the electron sources 14. The electron beams 15 impinge on the red, green, and blue phosphors 21, 22, 23, whereby the phosphors emit light and an image is formed. The BM 24 fills the gap between the red, green, and blue phosphors 21, 22, 23 and contributes to improving the image contrast. The BM 24 has, for example, a two-layer structure made of chromium and chromium oxide. The aluminum metal back 25 is formed so as to cover the red, green, and blue phosphors 21, 22, 23 as well as the BM 24. A high voltage ranging from approximately 8 to 10 kV is applied to the metal back 25, and accelerates the electron beams 15. The accelerated electron beams 15 penetrate the metal back 25 and impinge on the red, green, and blue phosphors 21, 22, 23 to cause the phosphors to emit light.

To maintain the vacuum in the display device, the cathode substrate 1 and the anode substrate 2 are sealed with a frame member 31 and a sealing material 32. The cathode substrate 1 and the anode substrate 2 are the thickness of approximately 3 mm. The distance between the cathode substrate 1 and the anode substrate 2 is approximately 2.8 mm, so that a high-field state is created in the display device.

FIG. 4 is a schematic cross-sectional view taken along the line B-B in FIG. 1. In FIG. 4, the data signal lines 12 extend on the cathode substrate 1 in the horizontal direction. The scan lines 11 extend in the direction perpendicular to the data signal lines 12 and in the direction of a normal to the plane of view. Each of the scan lines 11 has a multilayer structure in order to reduce wiring resistance. The electron sources 14 are disposed on the portions of the data signal lines 12 between the scan lines. Each of the electron sources 14 is formed from an upper electrode by which the corresponding data signal line 12 is electrically connected to the corresponding scan line 11 via a lower electrode and a tunnel insulating film. The red, green, and blue phosphors 21, 22, 23 are formed on the anode substrate 2, and the gap between the phosphors is filled with the BM24. Sputtering is used to cover the phosphors and the BM24 with aluminum, whereby the metal back 25 is formed. The anode voltage, which is a high voltage ranging from approximately 8 to 10 kV, is applied to the metal back 25. The anode voltage accelerates the electron beams 15 emitted from the electron sources 14. The electron beams 15 emitted from the electron sources 14 penetrate the metal back 25, and impinge on the red, green, and blue phosphors 21, 22, 23. A color image is thus formed. The electron beam 15 emitted from each of the electron sources 14 spreads, and the degree of the divergence is designed in such a way that the spreading electron beam 15 is slightly larger than each of the phosphors.

The spacers 4 are disposed to maintain the distance between the anode substrate 2 and the cathode substrate 1, as described with reference to FIG. 3. The spacers 4 are disposed between scan lines 11 on the cathode substrate 1 and the metal back 25 on the anode substrate 2. According to such an arrangement, the spacers 4 will not interfere with the phosphors and hence image formation.

FIG. 5 is a cross-sectional view taken along the line C-C in FIG. 1. In FIG. 5, the exhaust hole 10 is formed in the cathode substrate 1, and the display device is evacuated and the high voltage is supplied through the exhaust hole 10. The exhaust substrate 6 is disposed so as to cover the exhaust hole 10 in the cathode substrate 1 via the exhaust substrate sealing portion 7, and the vacuum in the display device is maintained. Specifically, the exhaust substrate 6 and the exhaust substrate sealing portion 7 form a box-shaped portion that covers the portion of the cathode substrate 1 including the exhaust hole 10, and thereby maintains the vacuum. The exhaust substrate sealing portion 7 basically has the same configuration as that of the sealing portion 3 between the cathode substrate 1 and the anode substrate 2. Specifically, an exhaust substrate frame 71 along with the sealing material 32 seals the cathode substrate 1 and the exhaust substrate 6.

The high-voltage introduction button 60 is attached to the exhaust substrate 6 by using the sealing material 32, and hermetically seals off the interior. The sealing material 32 is, for example, made of frit glass. The high-voltage introduction button is made of an Fe—Ni alloy. The composition ratio of the Fe—Ni alloy is selected in such a way that the thermal expansion coefficient of the Fe—Ni alloy is comparable to that of the sealing material 32. The contact spring 50 is spot-welded to the high-voltage introduction button 60. The contact spring 50 is made of Inconel, which can be readily spot-welded to an Fe—Ni alloy.

The bending stress produced when the contact spring 50 is bent causes the contact spring 50 to come into contact with the metal back 25 formed on the anode substrate 2 under an appropriate force. In the embodiment, the contact pressure exerted by the contact spring 50 is approximately 10 g. The contact portion of the contact spring 50 is shaped into an appropriate curved surface, such as a spherical surface, so that the contact portion stably comes into contact with the metal back 25. The material of the contact spring 50 is Inconel in consideration of heat resistance and other factors, and the thickness of the contact spring 50 is approximately 0.1 mm.

The anode terminal 26 that comes into contact with the contact spring 50 is formed on the anode substrate 2. Reliability is an important issue because a relatively large amount of current flows through the anode terminal 26. In the embodiment, the portion where the anode terminal 26 is formed has a structure described as follows. The BM 24 made of chromium and chromium oxide is formed on the anode substrate 2, and the aluminum metal back 25 is formed in such a way that the metal back 25 covers the BM 24. This configuration is the same as that of the effective plane of the screen. In the embodiment, as the anode terminal 26, a conductive film is formed to a thickness ranging from 10 to 30 μm on the metal back 25. In the embodiment, a silver paste is applied by printing and baked to form the conductive film. The conductive film may be baked, for example, in the baking process in which the spacer 4 is bonded. No special separate process is required only to bake the anode terminal conductive film.

The silver paste is obtained by dispersing silver particles, each having a diameter ranging from one to a few micrometers, in a high-viscosity organic solvent. The silver paste becomes conductive after the baking in which the silver particles are interconnected. The conductive film should have a certain amount of resistance in some cases. In such cases, the resistance can be adjusted by further mixing a frit glass paste in a typical silver paste. The material of the conductive film is not limited to a silver paste, but can be, for example, an Ni paste in which Ni particles are dispersed and an Al paste in which Al particles are dispersed. Even a binder-bonded black lead film can be used. In this case, the black lead is preferably graphite. The resistance of the black lead film can be adjusted, for example, by mixing red iron oxide with black lead.

Forming the conductive film in such a way that the thickness thereof is as thick as 10 to 30 μm enables the contact spring 50 to come stably into contact with the conductive film. In a case where the anode terminal 26 is formed from a metal film, the contact between the contact spring 50 and the metal film is made in discrete points. Therefore, the current is concentrated in the portions where the points are in contact, and a large risk is presented insofar as the contact may be broken. The conductive film used in the embodiment, however, provides a contact area between the conductive film and the contact spring 50 that is larger than the contact area in the case where a metal film is used. Such a larger contact area results in a state close to surface contact, which is stable contact. Further, the conductive film in the embodiment has a larger resistance than metal. It is therefore possible to prevent a large amount of current from flowing through the contact portion, which can also improve the stability of conduction through the contact portion.

An exhaust substrate exhaust hole 81 is formed in the exhaust substrate 6, and the exhaust tube 8 is connected to the exhaust substrate exhaust hole 81 via frit glass as the sealing material 32. The display device is evacuated through the exhaust tube 8. The exhaust tube 8 is then tipped off, and the inside of the display device is maintained at a vacuum. FIG. 5 shows the tipped-off exhaust tube 8.

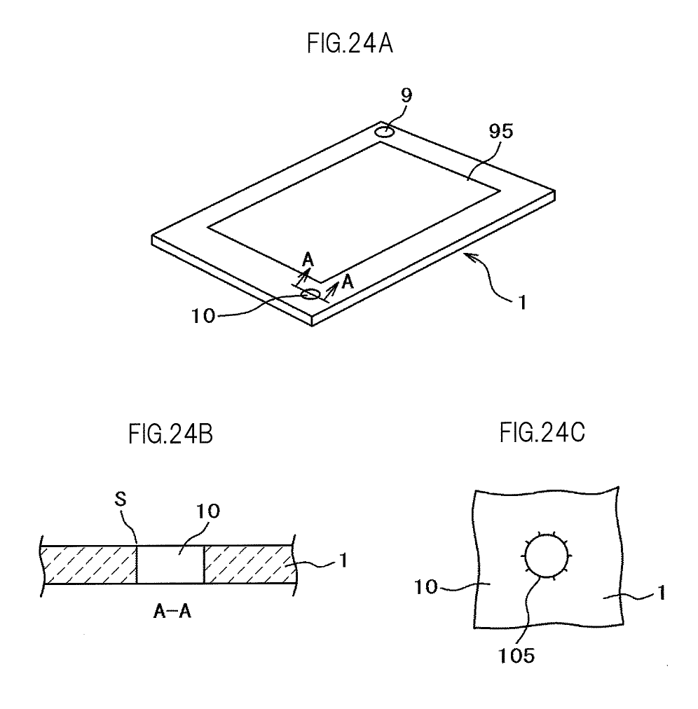

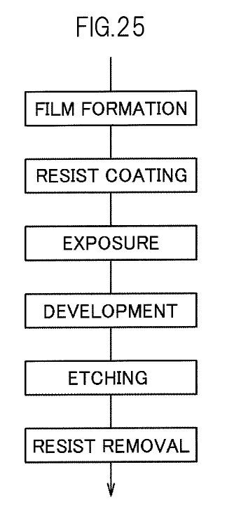

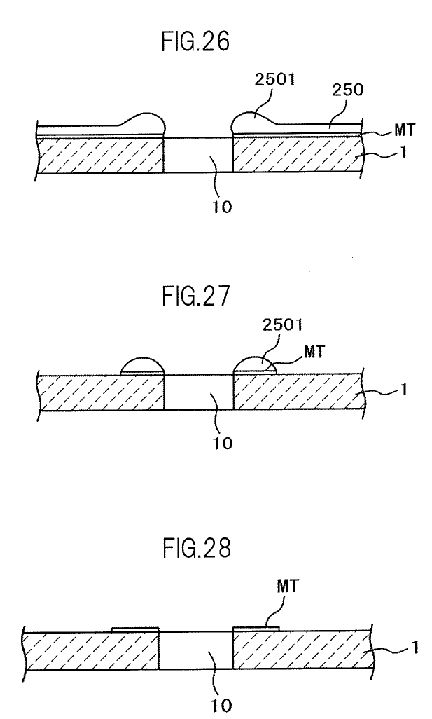

In FIG. 5, a chamfer 101 is formed on the exhaust hole 10. The sharp edge S shown in FIG. 24B, which shows related art, can be removed by forming the chamfer 101. The formation of the chamfer 101 can also prevent generation of tiny cracks 105 in the surface of the exhaust hole 10 shown in FIG. 24C. This is because forming the chamfer 101 changes the right angle at the edge into obtuse angles, so that tiny cracks are unlikely to be generated. Since a high voltage ranging from 8 to 10 kV is applied between the cathode substrate 1 and the anode substrate 2 with a gap of approximately 2.8 mm therebetween, a sharp edge becomes the point where sparking starts. In the embodiment, however, the formation of the chamfer 101 on the exhaust hole 10 can prevent electric field concentration.

Another advantage obtained by forming the chamfer 101 on the exhaust hole 10 is that the chamfer 101 can prevent the generation of tiny cracks around the exhaust hole 10 as described above. Tiny cracks may break away into small glass particles after the display device has been completed. Such foreign matter within the tube significantly lowers the withstand voltage of the display device. Forming the chamfer 101 in the embodiment can greatly reduce the amount of such foreign matter within the tube and hence provide a significantly advantageous effect of increasing the withstand voltage.

Still another advantage of forming the chamfer 101 on the exhaust hole 10 is that the chamfer 101 can prevent the generation of a metal film or other residue in a region close to the exhaust hole, as described above. A leading cause of the formation of such a metal film or other residue is the formation of a thick portion of the resist 250 at the edge of the exhaust hole 10 due to the surface tension of the resist. Forming the chamfer 101 at the edge of the exhaust hole as shown in the embodiment can prevent a thick portion of the resist 250 from being generated at the end part of the exhaust hole.

FIG. 7 is a schematic view showing the formation of the chamfer 101 at an end part of the exhaust hole 10 as well as a metal film MT. In FIG. 7, the metal film MT is formed, for example, by sputtering, and the metal film MT is formed also on the chamfer 101 on the exhaust hole 10 although the metal film MT of this portion is thin. Since the chamfer 101 is formed at the edge of the exhaust hole 10, the resist 250 flows smoothly, and no partially thick portion is produced. Therefore, when developed, the resist 250 will not be left at the edge of the exhaust hole 10, and hence no metal film or other residues will be left.

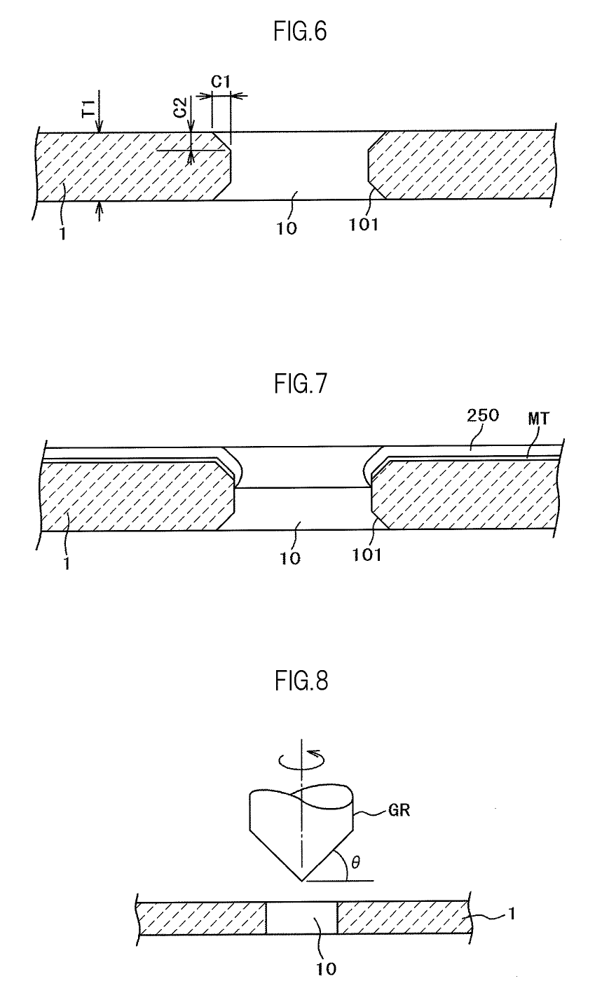

FIG. 6 shows a case where a so-called straight chamfer has been formed at an end part of the exhaust hole 10. The chamfer can be variously sized. In general, although the values of C1 and C2 in FIG. 6 are preferably the same, they may be changed in accordance with the withstand voltage characteristics and the state of resist formation in the photolithography process. Even a small chamfer 101 provides a significantly advantageous effect. For example, when C1 and C2 in FIG. 6 are at least 0.05 mm in length, an advantageous effect is provided. More preferably, C1 and C2 in FIG. 6 are at least 0.5 mm in length.

FIG. 8 shows a method for forming the chamfer 101 on the exhaust hole 10. As shown in FIG. 8, the chamfer 101 can be readily formed merely by moving a rotating grinder GR so as to touch an end part of the exhaust hole. The grinding is performed while water is applied to the portion being ground for cooling purposes. Changing the θ of the grinder GR in FIG. 8 enables the ratio of C1 to C2 in FIG. 6 to be readily changed. The size of C1 or C2 can be changed according to the depth to which the grinder GR is inserted into the exhaust hole 10.

FIG. 5 shows the chamfers 101 formed on both sides of the exhaust hole 10 formed in the cathode substrate 1. It is desirable to form the chamfers 101 on both sides of the cathode substrate 1 as shown in FIG. 5; however, in a case where a chamfer is formed only on one side in consideration of the manufacturing process, it is necessary to form the chamfer on the surface of the cathode substrate 1 that faces the anode substrate 2.

The exhaust hole 10 formed in the cathode substrate 1 has been described in the foregoing sections. However, the problem related to the withstand voltage as caused by sparking similarly occurs with the high-voltage introduction button hole 82 and the exhaust substrate exhaust hole 81 formed in the exhaust substrate 6 in FIG. 5. In the embodiment, as shown in FIG. 5, chamfers similar to those on the exhaust hole 10 formed in the cathode substrate 1 are formed at the high-voltage introduction button hole 82 and the exhaust substrate exhaust hole 81 formed in the exhaust substrate 6. Since the exhaust substrate 6 is worked without undergoing a photolithography step, the chamfers of the high-voltage introduction button hole 82 and the exhaust substrate exhaust hole 81 may differ in size relative to the chamfers 101 on the exhaust hole 10 formed in the cathode substrate 1.

The same argument applies to a case where the hole formed in the cathode substrate 1 is not the exhaust hole 10 but the getter hole 9. In this case, a getter is placed in a space surrounded by the cathode substrate 1, the exhaust substrate 6, and the exhaust substrate frame 71 in FIG. 5. In this case, the configuration described above can be applied merely by replacing the exhaust hole 10 in FIG. 5 with the getter hole 9. The getter may also be placed in the same space as the space in which the contact spring 50 for introducing high voltage, the exhaust substrate exhaust hole 81, and the like are disposed as shown in FIG. 5.

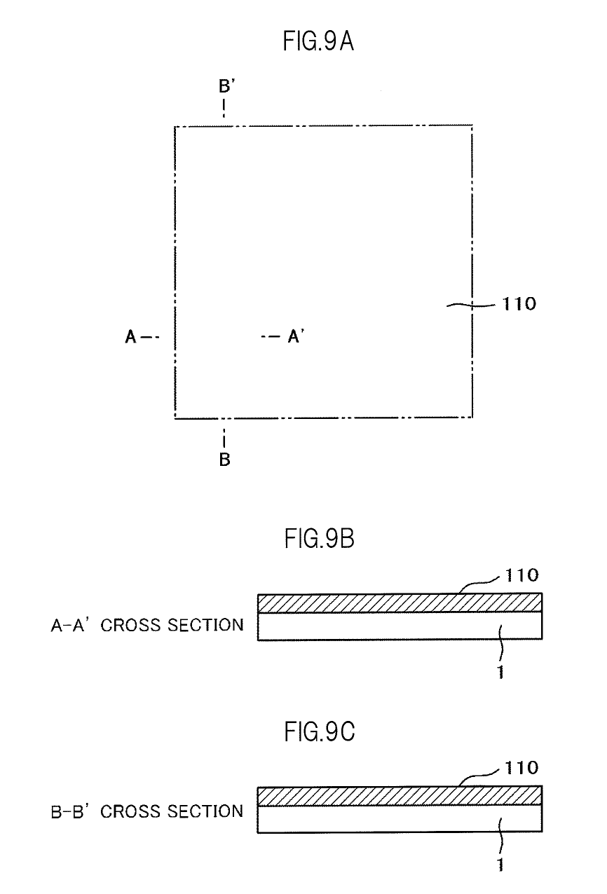

FIGS. 9A to 20C show the processes of forming the cathode substrate 1 by using cathode substrate glass formed in the embodiment. The following description is made with reference to the cathode substrate 1 using MIM electron sources. In this case, since the data signal line 12 is the lower electrode of an MIM electron source, the term “data signal line 12” is replaced with the term “lower electrode” in the following description.

FIG. 9A is a plan view showing an arrangement wherein a metal film for a lower electrode 110 is formed on the cathode substrate 1. FIG. 9B is a cross-sectional view taken along the line A-A′ in FIG. 9A, and FIG. 9C is a cross-sectional view taken along the line B-B′ in FIG. 9A. First, as shown in FIGS. 9A to 9C, the metal film for the lower electrode 110 is formed on the cathode substrate 1. The material of the lower electrode 110 is an Al-based material. An Al-based material is used because a good insulating film may be formed therewith using anodizing. In the embodiment, an Al—Nd alloy doped with 2 atomic wt % of Nd is used. The film is formed by sputtering or another technique. The metal film for the resulting lower electrode 110 has a thickness of 600 nm.

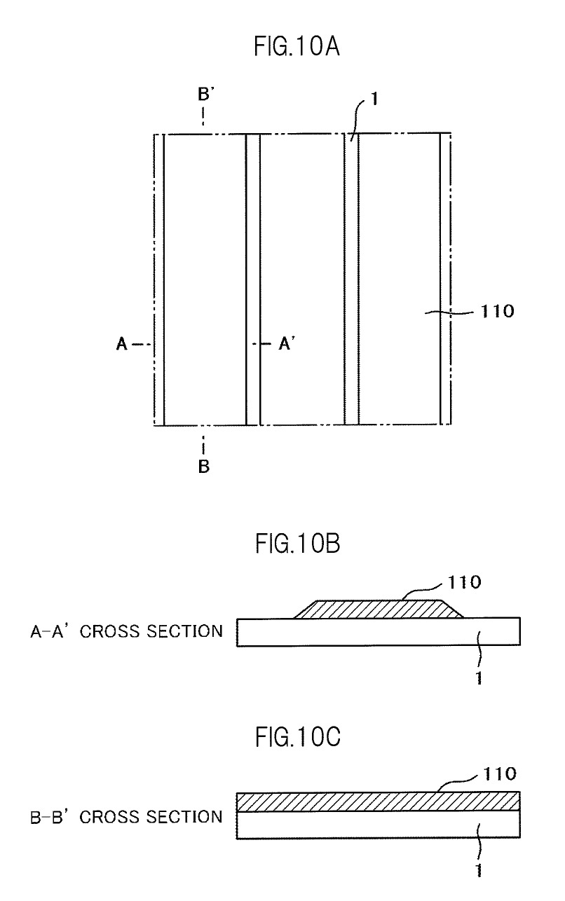

FIG. 10A is a plan view showing an arrangement wherein the lower electrode 110 is shaped in the form of stripes. FIG. 10B is a cross-sectional view taken along the line A-A′ in FIG. 10A, and FIG. 10C is a cross-sectional view taken along the line B-B′ in FIG. 10A. After the film is formed, the stripe-shaped lower electrode 110 is formed in a patterning step and an etching step (FIGS. 10A to 10C). The width of the lower electrode 110 varies in accordance with the size and the resolution of the image display device, and, in the embodiment, substantially corresponds to the interval between subpixels (approximately 100 to 200 μm in the embodiment) in the image display device. Since the electrode has a simple, wide-stripe structure, the resist can be patterned, for example, via inexpensive proximity exposure and printing.

Since the lower electrode 110 is the lowest film on the cathode substrate and a variety of films are layered on the lower electrode 110, the ends of the lower electrode 110 are desirably tapered. To this end, the ends are etched via wet etching using an etchant obtained by mixing phosphoric acid, acetic acid, and nitric acid with water. Increasing the proportion of nitric acid enables resist erosion during the etching to be promoted, and the ends of the lower electrode 110 being worked to be tapered.

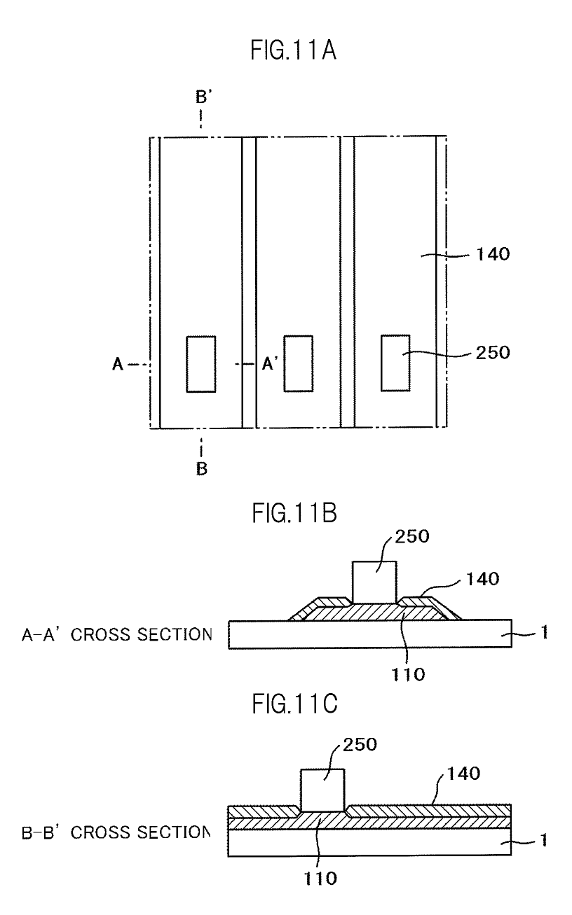

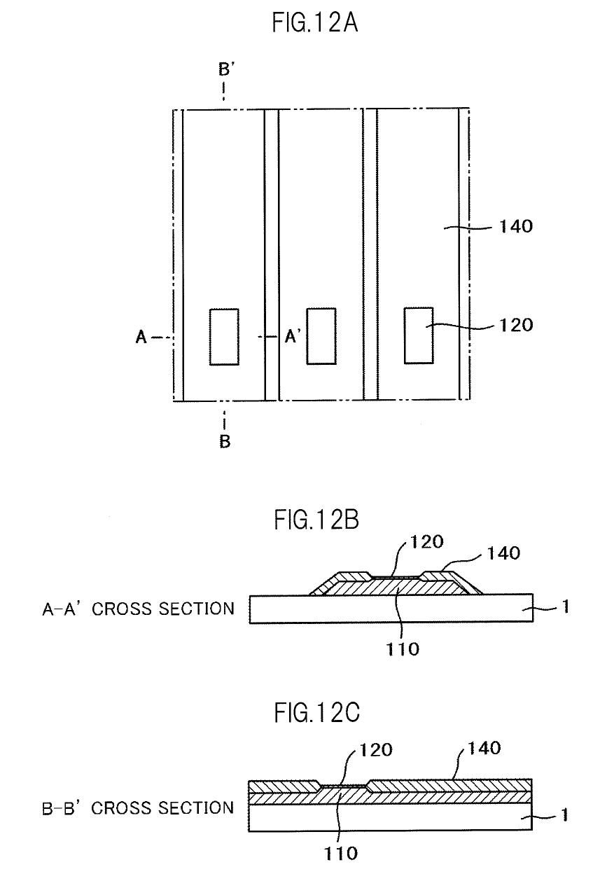

A protective insulating layer 140 and an insulating layer 120 are then formed. The protective insulating layer 140 defines an electron emitting portion and prevents electric field concentration at the edges of the lower electrode 110. FIG. 11A is a plan view showing an arrangement wherein the protective insulating layer 140 is formed by using a resist film 250 to mask the portion of the lower electrode 110 that becomes the electron emitting portion, and selectively anodize the other portions to an increased thickness. FIG. 11B is a cross-sectional view taken along the line A-A′ in FIG. 11A, and FIG. 11C is a cross-sectional view taken along the line B-B′ in FIG. 11A. In the embodiment, the formation voltage is set to 200 V, and the protective insulating layer 140 is formed to a thickness of approximately 280 nm. The resist film 250 is then removed, and the remaining surface of the lower electrode 110 is anodized. In the embodiment, the formation voltage is set to 4 V, and the insulating layer (tunnel insulating layer) 120 having a thickness of approximately 8 nm is formed on the lower electrode 110. FIG. 12A is a plan view showing an arrangement wherein the tunnel insulating layer 120 is formed on the lower electrode 110. FIG. 12B is a cross-sectional view taken along the line A-A′ in FIG. 12A, and FIG. 12C is a cross-sectional view taken along the line B-B′ in FIG. 12A.

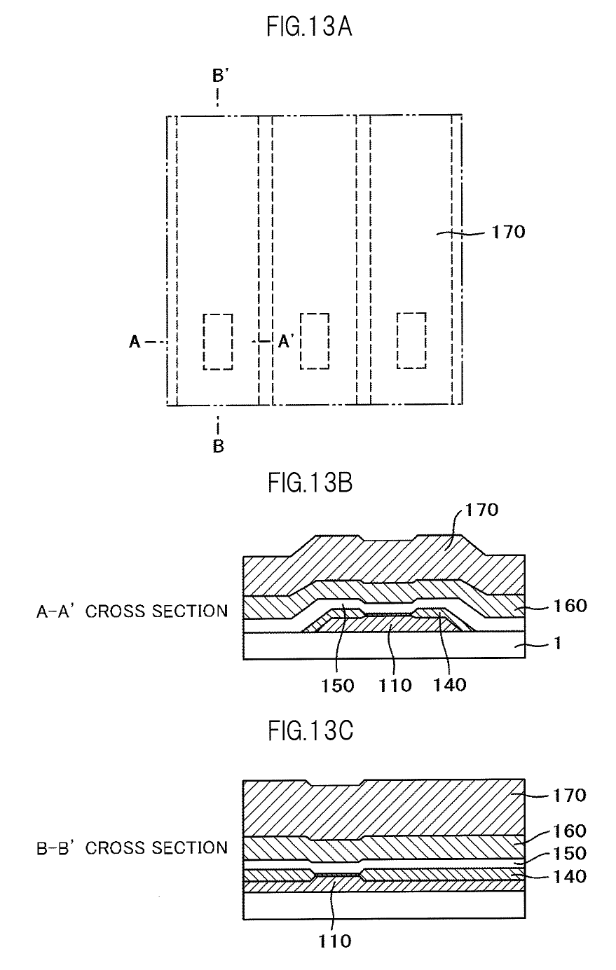

FIG. 13A is a plan view showing an arrangement wherein a film is formed from an interlayer film (interlayer insulating film) and a metal film that becomes an upper bus electrode 170 that becomes a feed line to an upper electrode 130. The interlayer film (interlayer insulating film) and the metal film that becomes the upper bus electrode 170 that becomes the feed line to the upper electrode 130 are formed, for example, by sputtering. FIG. 13B is a cross-sectional view taken along the line A-A′ in FIG. 13A, and FIG. 13C is a cross-sectional view taken along the line B-B′ in FIG. 13A. The interlayer film can be, for example, a silicon oxide film and a silicon nitride film. In the embodiment, the interlayer film is a laminate of a silicon nitride film 150 having a thickness of 200 nm and a silicon film 160 having a thickness of 300 nm. The silicon nitride film 150 serves to maintain insulation between the lower electrode 110 and the upper bus electrode 170 in a case where there are pinholes in the protective insulating film 140 formed by anodizing. Specifically, such defects are filled with the silicon nitride film 150. The silicon film 160 is used to separate the upper electrode 130, which is achieved by forming an undercut 190 in a later processing step at the side surface of the upper bus electrode 170.

The metal film, which becomes the upper bus electrode 170, is formed, for example, by sputtering. Since the upper bus electrode 170 is used as a scan electrode, the resistance thereof needs to be lower than the resistance of the lower electrode 110, which becomes a data electrode. In the embodiment, the upper bus electrode 170 is made of pure aluminum having a low resistivity, and the film thickness of the upper bus electrode 170 is 4.5 μm in order to reduce wiring resistance.

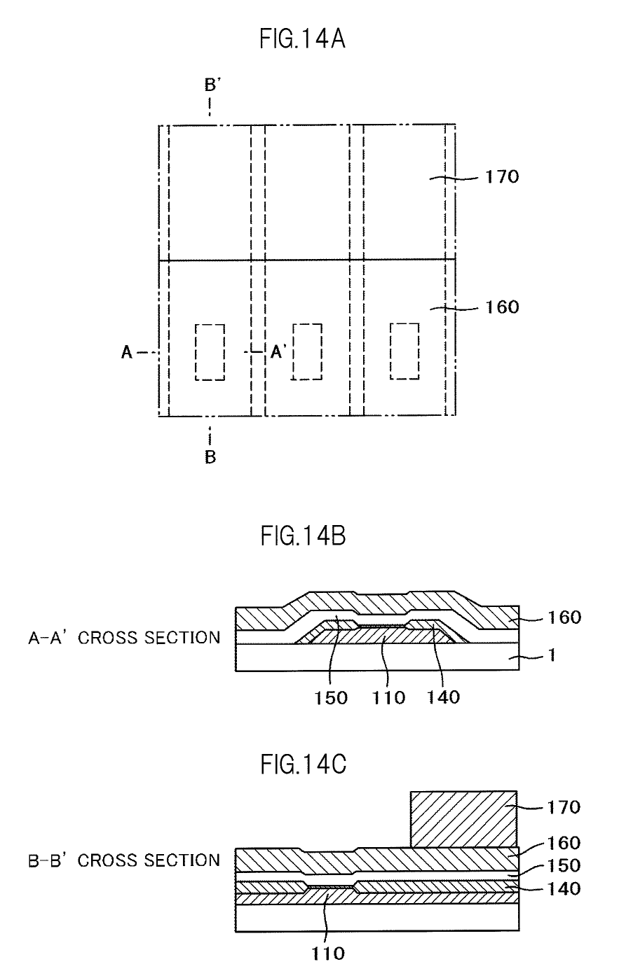

The upper bus electrode 170 is then worked. FIG. 14A is a plan view showing the worked upper bus electrode 170. FIG. 14B is a cross-sectional view taken along the line A-A′ in FIG. 14A, and FIG. 14C is a cross-sectional view taken along the line B-B′ in FIG. 14A. The upper bus electrode 170 is disposed perpendicular to the lower electrode 110 and next to the electron emitting portions. Wet etching is carried out using, for example, a solution obtained by mixing phosphoric acid, acetic acid, and nitric acid with water (FIGS. 14A to 14C).

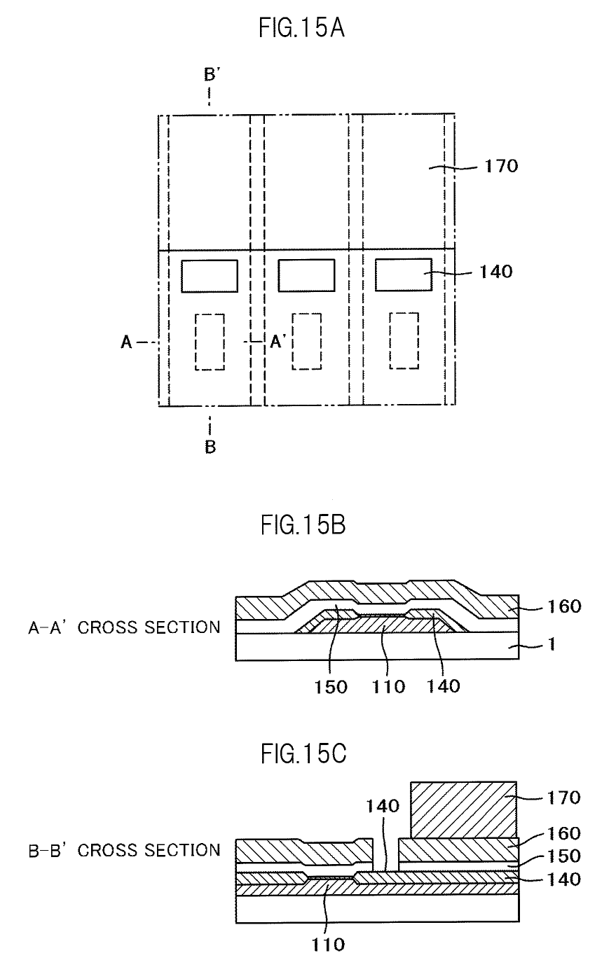

Subsequently, a through-hole is formed in the interlayer film between the upper bus electrode 170 and the tunnel insulating layer 120 above the protective insulating film 140. FIG. 15A is a plan view showing an arrangement wherein the through-hole is formed in the interlayer film between the upper bus electrode 170 and the tunnel insulating layer 120 above the protective insulating film 140. FIG. 15B is a cross-sectional view taken along the line A-A′ in FIG. 15A, and FIG. 15C is a cross-sectional view taken along the line B-B′ in FIG. 15A. Dry etching is carried out using an etching gas primarily made of, for example, CF₄ and SF₆. The silicon nitride film 150 and the silicon film 160 are etched (FIGS. 15A to 15C).

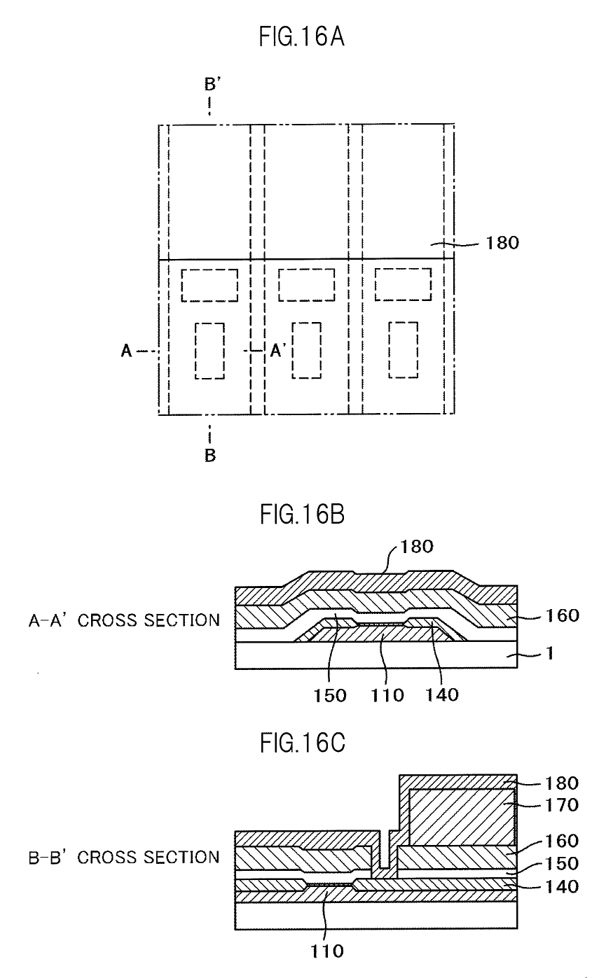

A metal film for a contact electrode, which electrically connects the upper bus electrode to the upper electrode, is then formed by sputtering. FIG. 16A is a plan view showing an arrangement wherein the metal film for the contact electrode, which electrically connects the upper bus electrode to the upper electrode is formed. FIG. 16B is a cross-sectional view taken along the line A-A′ in FIG. 16A, and FIG. 16C is a cross-sectional view taken along the line B-B′ in FIG. 16A. In the embodiment, the metal film for the contact electrode is made of an Al—Nd alloy doped with 2 atomic wt % of Nd, as in the lower electrode. The metal film for the contact electrode is formed, for example, by sputtering, and the thickness of the metal film is 300 nm (FIGS. 16A to 16C).

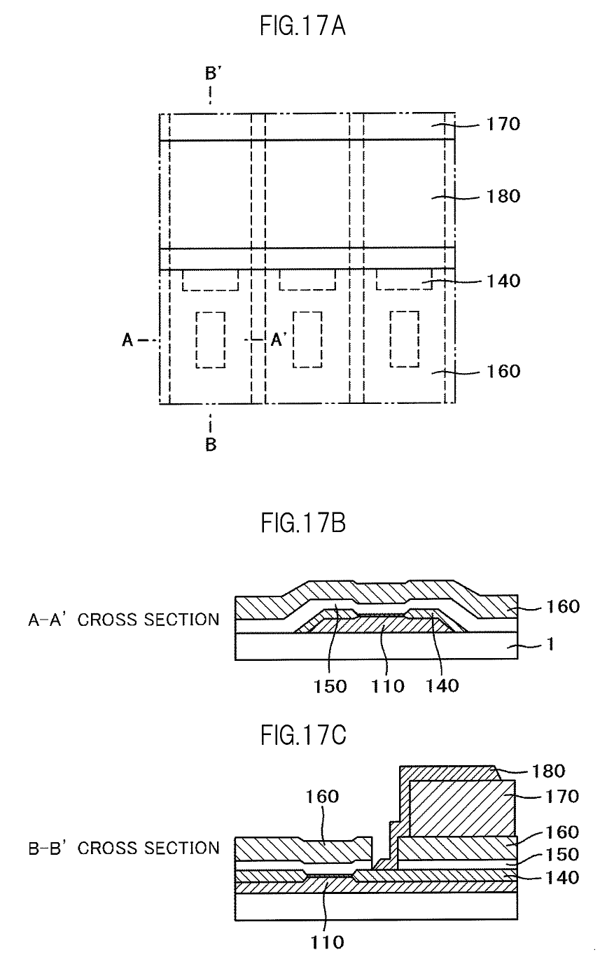

The contact electrode 180 is then worked. FIG. 17A is a plan view showing an arrangement wherein the contact electrode 180 has been worked. FIG. 17B is a cross-sectional view taken along the line A-A′ in FIG. 17A, and FIG. 17C is a cross-sectional view taken along the line B-B′ in FIG. 17A. To taper the contact electrode 180 as in the lower electrode 110, wet etching is carried out using an etchant obtained by mixing phosphoric acid, acetic acid, and nitric acid with water. Increasing the proportion of nitric acid enables the resist erosion that takes place during the etching to be promoted, and the ends of the contact electrode 180 being worked to be tapered.

As shown in FIG. 17C, the contact electrode 180 is worked into a shape such that the end closer to the tunnel insulating layer 120 extends across the through-hole, and the end away from the tunnel insulating layer 120 lies on the upper bus electrode 170. Forming the end of the contact electrode 180 in the through-hole enables a contact portion to be formed on the protective insulating film 140. The upper electrode 130, which will be formed later, is allowed to extend from the upper bus electrode 170 to the protective insulating film 140 without passing the step of the silicon nitride film 150 and the silicon film 160. It is therefore possible to prevent the upper electrode 130 from being disconnected by a step.

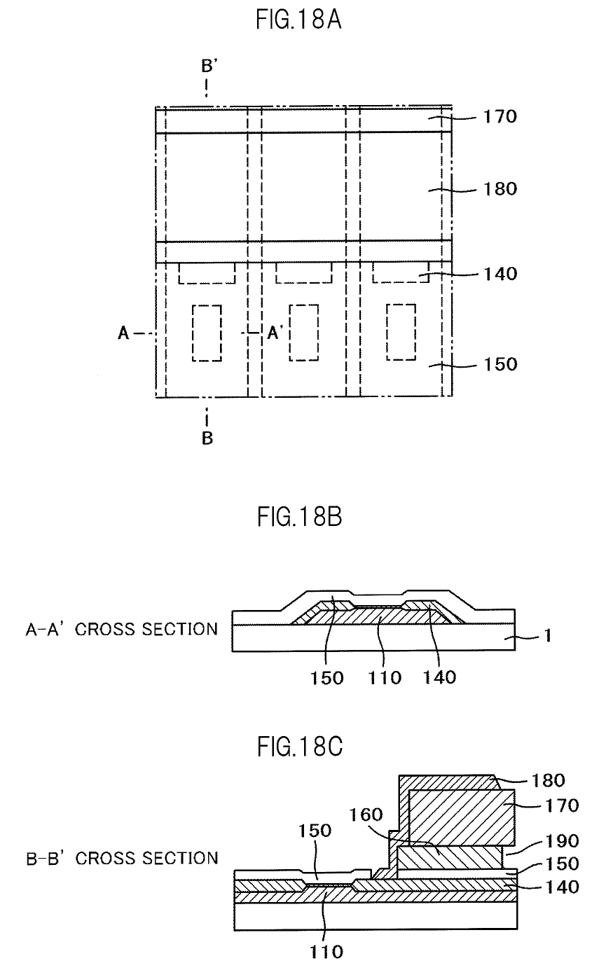

The silicon film 160, which is the interlayer film, is then subjected to dry etching at a high selection ratio with respect to the silicon nitride film 150 so that an undercut 190 is formed under the side surface of the upper bus electrode 170 on the side opposite the through-hole. FIG. 18A is a plan view showing the undercut 190 formed under the side surface of the upper bus electrode 170 that is opposite to the tunnel insulating layer 120. FIG. 18B is a cross-sectional view taken along the line A-A′ in FIG. 18A, and FIG. 18C is a cross-sectional view taken along the line B-B′ in FIG. 18A. The dry etching is carried out using a mixture of CF₄ and O₂ gases or a mixture of SF₆ and O₂ gases. Although each of the gases etches the Si as well as the SiN, the Si can be etched more quickly than the SiN is etched by optimizing the proportion of O₂ (CF₄:O₂=2:1, for example). The undercut 190 serves to separate the upper electrode 130 for each upper bus electrode 170 (each scan line) when the upper electrode 130 is formed later.

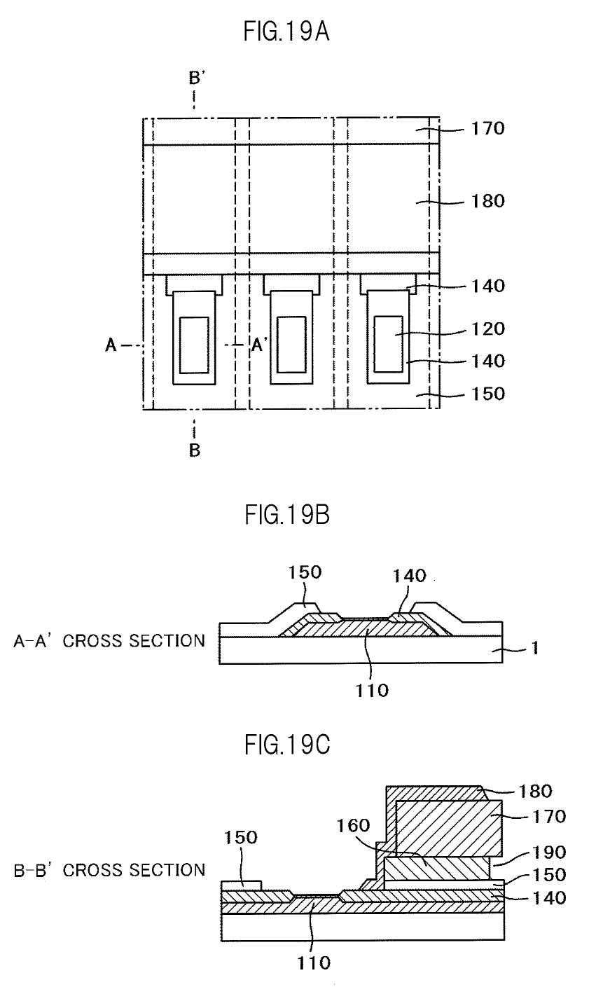

Then, the silicon nitride film 150 on the electron emitting portion is worked, and the electron emitting portion is exposed. FIG. 19A is a plan view showing an arrangement in which the silicon nitride film 150 on the electron emitting portion has been worked, and the electron emitting portion has been exposed. FIG. 19B is a cross-sectional view taken along the line A-A′ in FIG. 19A, and FIG. 19C is a cross-sectional view taken along the line B-B′ in FIG. 19A. Dry etching is carried out using an etching agent primarily made of, for example, CF₄ and SF₆ (FIGS. 19A to 19C).

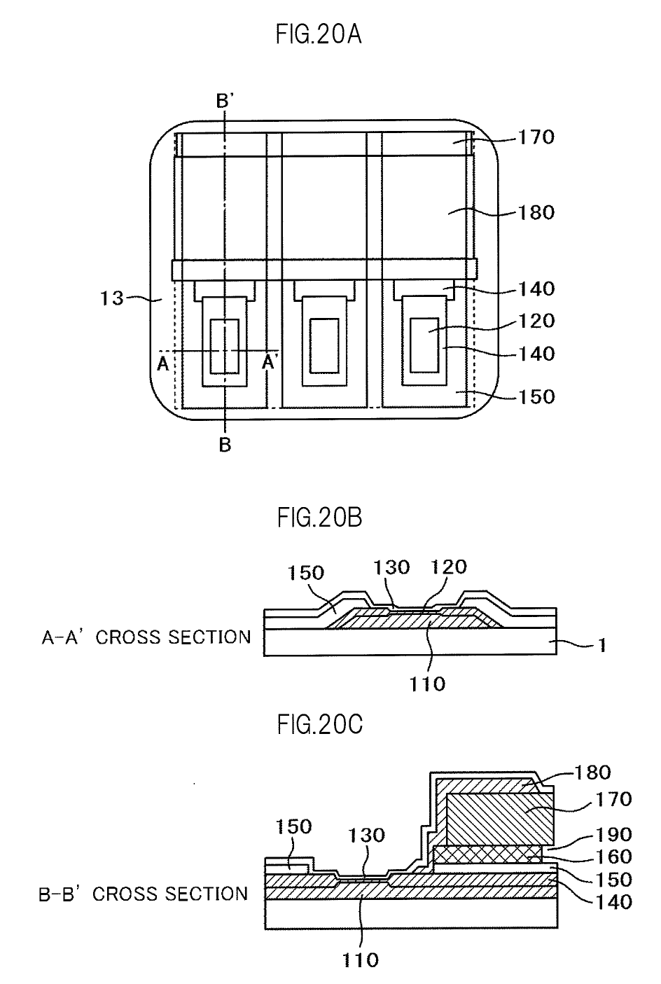

The upper electrode 130 is then formed, for example, by sputtering. FIG. 20A is a plan view showing an arrangement wherein the upper electrode 130 has been formed. FIG. 20B is a cross-sectional view taken along the line A-A′ in FIG. 20A, and FIG. 20C is a cross-sectional view taken along the line B-B′ in FIG. 20A. As the upper electrode 130, it is effective to use precious metals in the eighth group, which is the platinum group, and the 1b group that have a high transmittance of hot electrons. In particular, a film made of any of Pd, Pt, Rh, Ir, Ru, Os, Au, and Ag as well as a laminate made of any of the above elements is effectively used as the upper electrode 130. In the embodiment, a laminate film made of Ir, Pt, and Au with a film thickness ratio of 1:3:3 and a total film thickness of, for example, 3 nm is used. The upper electrode 130 is formed by sputtering a film.

As described above, a large number of fine working processes; i.e., a large number of photolithography steps, are required to form the cathode substrate 1. As shown in the embodiment, forming the chamfered exhaust hole 10 or getter hole 9 in the cathode substrate 1 prevents a metal film or other residue from being generated around the exhaust hole 10 and the like. It is also possible, for example, to prevent chipped glass pieces and other glass particles that drop off the end part of the exhaust hole 10, the getter hole 9, and other holes from being mixed in any of the above thin films in the manufacturing process.

### Second Embodiment

In the first embodiment described above, a so-called straight chamfer is formed on the exhaust hole 10. In a second embodiment, a so-called round chamfer 102 is formed on the exhaust hole 10 in the cathode substrate 1. Since the round chamfer 102 does not have an edged portion, unlike a straight chamfer, the advantageous effect of preventing electric field concentration and hence sparking is further enhanced. Forming the round chamfer 102 prevents the generation of tiny cracks in the surface of the exhaust hole 10 shown in FIG. 24C and hence the generation of small glass particles, as in the first embodiment.

An advantageous effect provided by forming the round chamfer 102 on the exhaust hole 10 is that the round chamfer 102 can prevent generation of a metal film or another residue in a region close to the exhaust hole, as described in the “Summary of the Invention” section. This advantageous effect is greater than that in a case where the straight chamfer 101 is used, because no edged portion is present in a case where the round chamfer 102 is used. This is because forming the round chamfer 102 is more effective in preventing the resist 250 from being thickly built up in an edged portion than in a case where the straight chamfer 101 is used.

FIG. 22 is a schematic view showing the arrangement described above. In FIG. 22, a metal film MT is formed by sputtering or another technique, but is also formed as a thin film on the round chamfer 102 on the exhaust hole 10. The round chamfer 102 formed at the edge of the exhaust hole 10 allows the resist 250 to flow smoothly, and hence no partially thick portion is produced. Therefore, when developed, the resist 250 will not be left at the edge of the exhaust hole 10, and hence no metal film or other residue will be left.

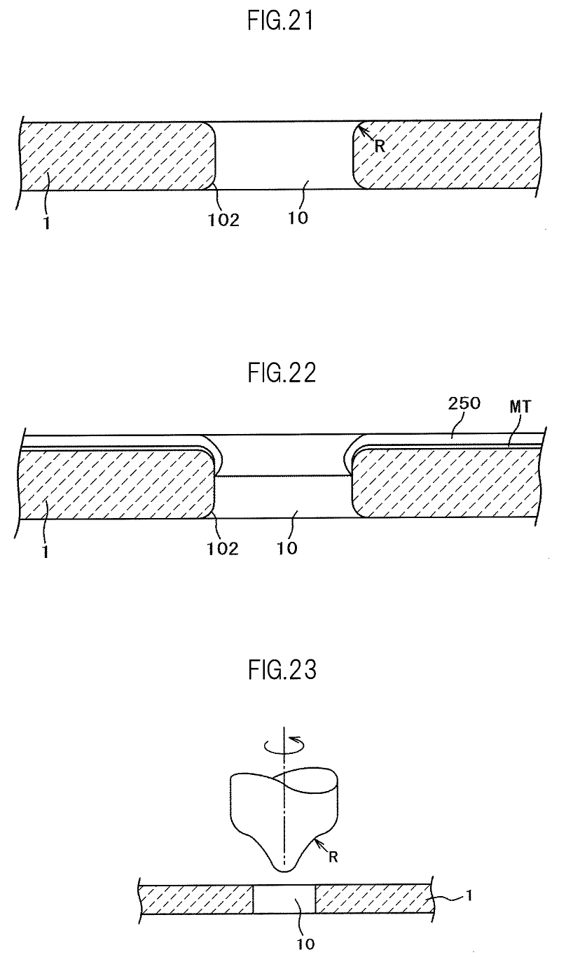

FIG. 21 shows a case where a round chamfer is formed at an end part of the exhaust hole 10. The radius R of the round chamfer 102 shown in FIG. 21 can be variously sized in consideration of, for example, the withstand voltage and the state of the resist buildup in the manufacturing process. Even a small round chamfer 102 provides a significantly advantageous effect. For example, when R shown in FIG. 21 is at least 0.05 mm in radius, an advantageous effect is provided. When R is 0.5 mm or greater, the advantageous effect can be enhanced.

FIG. 23 shows a method for forming the round chamfer 102 on the exhaust hole 10. As shown in FIG. 23, a round chamfer can be formed by causing a grinder GR to rotate and move so as to touch an end part of the exhaust hole. The grinding is performed while water is applied to the portion being ground for cooling purposes. The radius R of the round chamfer 102 in FIG. 21 corresponds to the curvature R of the side surface of the grinder GR in FIG. 23. The size of the round chamfer can be changed according to the depth to which the grinder GR is inserted into the exhaust hole 10.

A description has been provided of the round chamfer 102 being formed on the exhaust hole 10 formed in the cathode substrate 1. A round chamfer can be similarly formed, for example, at the high-voltage introduction terminal hole 82 and the exhaust substrate exhaust hole 81 formed in the exhaust substrate in FIG. 5 as well as the getter hole 9 and the like formed in the cathode substrate 1, as described in the first embodiment.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
a cathode substrate on which electron emitting sources are formed in a matrix; and
an anode substrate that faces the cathode substrate, is impressed with an anode voltage, and has phosphors formed at positions that correspond to the electron emitting sources,
the inside of the display device being maintained at a vacuum, wherein
a through-hole is formed in the cathode substrate; and
an end part of the through-hole facing the anode substrate is provided with a chamfer.

2. The display device of claim 1, wherein
the chamfer is a straight chamfer having a size of 0.05 mm or greater.

3. The display device of claim 1, wherein
the chamfer is a straight chamfer having a size of 0.5 mm or greater.

4. The display device of claim 1, wherein
the chamfer is a round chamfer having a radius of 0.05 mm or greater.

5. The display device of claim 1, wherein
the chamfer is a round chamfer having a radius of 0.5 mm or greater.

6. The display device of claim 1, wherein
the through-hole is an exhaust hole for evacuating the display device.

7. The display device of claim 1, wherein
both edges of the through-hole are provided with a chamfer.

8. A display device comprising:
a cathode substrate on which electron emitting sources are formed in a matrix; and
an anode substrate that faces the cathode substrate, is impressed with an anode voltage, and has phosphors formed at positions that correspond to the electron emitting sources,
the inside of the display device being maintained at a vacuum, wherein
a through-hole is formed in the cathode substrate;
a box-shaped portion is formed on a portion including the through-hole in a surface of the cathode substrate, the surface being opposite the anode substrate, the box-shaped portion being hermetically maintained at a vacuum; and
an end part of the through-hole formed in the cathode substrate and facing the anode substrate is provided with a chamfer.

9. The display device of claim 8, wherein
an exhaust hole for evacuating the interior of the display device is formed in the box-shaped portion; and
an end part of the exhaust hole is provided with a chamfer.

10. The display device of claim 8, wherein
a high-voltage introduction terminal insert hole for supplying an anode voltage to the display device is formed in the box-shaped portion; and
an end part of the high-voltage introduction terminal insert hole is provided with a chamfer.

11. The display device of claim 8, wherein
a contact spring for conducting electricity to the anode substrate is connected to a high-voltage introduction terminal; and
the contact spring passes through the through-hole formed in the cathode substrate.

12. The display device of claim 8, wherein
a getter for maintaining the vacuum in the display device is disposed in the box-shaped portion.
